(19) United States
(12) Patent Application Publication
(10) Pub. No.: US 2013/0093578 A1
(43) Pub. Date: Apr. 18, 2013

(54) VEHICLE EXISTENCE ANNUNCIATOR DEVICE AND METHOD FOR CONTROLLING THE SAME

(71) Applicant: Koichi Goto, Kariya-city (JP)

(72) Inventor: Koichi Goto, Kariya-city (JP)

(73) Assignee: DENSO CORPORATION, Kariya-city (JP)

(21) Appl. No.: 13/603,553

(22) Filed: Sep. 5, 2012

(30) Foreign Application Priority Data
Oct. 12, 2011 (JP) 2011-225020

(51) Int. Cl. B60Q 1/00

(52) U.S. Cl. 340/425.5

(57) ABSTRACT

A vehicle existence annunciator device drives a speaker by utilizing an electric power, which is supplied from an electric power source, to emit an annunciation sound to the outside of a vehicle. The vehicle existence annunciator device includes a counter-voltage-reduction unit configured to enhance a sound pressure level at a frequency, which is apt to linger in a human's ear, when a power supply voltage applied from the electric power source to the vehicle existence annunciator device decreases.

### CROSS REFERENCE TO RELATED APPLICATION

This application is based on reference Japanese Patent Application No. 2011-225020 filed on Oct. 12, 2011, the disclosure of which is incorporated herein by reference.

### TECHNICAL FIELD

The present disclosure relates to a vehicle existence annunciator device configured to emit an annunciation sound to the outside a vehicle and to notify existence of the vehicle. The present disclosure relates to a method for controlling the vehicle existence annunciator device. The present disclosure may be employable in, for example, a quiet vehicle, such as an electric vehicle, a fuel cell vehicle, or a hybrid vehicle.

### BACKGROUND

For example, JP-A-2011-148433, which corresponds to US 2011-0181442 A1, discloses a vehicle existence annunciator device configured to emit an annunciation sound to notify people around the vehicle of existence of the vehicle. Such a vehicle existence annunciator device is required to emit an annunciation sound, such as a dummy engine sound, a chord sound, a voice, a music, and/or the like, which does not cause a human to feel noisy. That is, such an annunciation sound is dissimilar to an alarm sound, such as a whistle sound, emitted from a vehicular warning device such as a vehicular horn buzzer.

In general, a vehicle existence annunciator device is configured to utilize a vehicular electric power source, such as a battery, to drive a speaker thereby to cause the speaker to emit an annunciation sound. Therefore, the output of the speaker, which relates to a sound pressure of an annunciation sound, depends on the voltage of the vehicular electric power source. The state of a vehicular electric power source varies in dependence upon various factors, such as its temperature and/or its aging state. Specifically, in a configuration where the rating voltage of a vehicular electric power source is 12V, its output voltage is normally in a range between 12 V and 16 V. Alternatively, the output voltage of the vehicular electric power source may decrease to a low voltage range, for example, between 10 V and 12 V, less than 12V, due to various factors, such as its temperature and/or its aging state.

Accordingly, when the output voltage of the vehicular electric power source decreases below the rating voltage, such as 12V, an input voltage of the vehicle existence annunciator device decreases correspondingly. Consequently, the sound output of the speaker decreases to result in incapability of emission of an annunciation sound in its specified range. Thus, the vehicle existence annunciation device cannot appropriately notify existence of the vehicle.

Herein, it is conceivable to increase the number of speakers equipped to the vehicle in order to enable notification of existence of the vehicle to people therearound in such a condition where the power supply voltage decreases. Nevertheless, in such a configuration with a large number of speakers, manufacturing cost for the vehicle existence annunciation device may increase, and mountability of the vehicle existence annunciation device may be impaired.

### SUMMARY

It is an object to produce a vehicle existence annunciator device configured to notify existence of a vehicle even in a state where an output voltage of a vehicular electric power source decreases. It is another object to produce a method for controlling the vehicle existence annunciator device.

According to an aspect of the present disclosure, a vehicle existence annunciator device configured to drive a speaker with an electric power, which is supplied from a vehicular electric power source, to emit an annunciation sound to an outside of a vehicle, when an operating condition for notifying existence of the vehicle is satisfied, the vehicle existence annunciator device comprises a voltage determination unit configured to determine whether a power supply voltage applied from the vehicular electric power source to the vehicle existence annunciator device decreases. The vehicle existence annunciator device further comprises a counter-voltage-reduction unit configured to enhance a sound pressure level at a frequency, which is apt to linger in a human's ear, when the voltage determination unit determines that the power supply voltage decreases.

According to another aspect of the present disclosure, a vehicle existence annunciator device configured to drive a speaker with an electric power, which is supplied from a vehicular electric power source, to emit an annunciation sound to an outside of a vehicle, when an operating condition for notifying existence of the vehicle is satisfied, wherein the speaker is configured to emit the annunciation sound through an acoustic tube, the vehicle existence annunciator device comprises a voltage determination unit configured to determine whether a power supply voltage applied from the vehicular electric power source to the vehicle existence annunciator device decreases. The vehicle existence annunciator device further comprises a counter-voltage-reduction unit configured to enhance a sound pressure level at a resonant frequency of the acoustic tube, when the voltage determination unit determines that the power supply voltage decreases.

According to another aspect of the present disclosure, a method for controlling a vehicle existence annunciator device to drive a speaker with an electric power, which is supplied from a vehicular electric power source, to emit an annunciation sound to an outside of a vehicle, the method comprises determining whether a power supply voltage applied from the vehicular electric power source to the vehicle existence annunciator device decreases below a threshold. The method further comprises enhancing, on determination that the power supply voltage decreases below the threshold, at least one of: a sound pressure level at a frequency, which is apt to linger in a human's ear; and a sound pressure level at a resonant frequency of an acoustic tube through which the speaker is configured to emit the annunciation sound.

According to another aspect of the present disclosure, a vehicle existence annunciator device configured to drive a speaker with an electric power, which is supplied from an electric power source of a vehicle, to emit an annunciation sound to an outside of the vehicle, the vehicle existence annunciator device comprises a voltage determination unit configured to determine whether a power supply voltage applied from the electric power source to the vehicle existence annunciator device decreases below a threshold. The vehicle existence annunciator device further comprises a counter-voltage-reduction unit configured, when the voltage determination unit determines that the power supply voltage decreases below the threshold, to enhance at least one of: a sound pressure level at a frequency, which is apt to linger in a human's ear; and a sound pressure level at a resonant frequency of an acoustic tube through which the speaker is configured to emit the annunciation sound.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a vehicle existence annunciator device;

FIG. 2A is a sectional view showing a vehicular horn buzzer equipped with a piezoelectric speaker, and FIG. 2B is a schematic view showing the vehicular horn buzzer equipped with the piezoelectric speaker;

FIG. 3 is a graph showing loudness curves each representing a sound pressure felt by a human with respect to a constant sound pressure level; and

FIG. 4 is a graph showing a frequency characteristic curve, which represents a playback sound caused by a piezoelectric speaker itself, and a frequency characteristic curve, which represents a playback sound caused by the piezoelectric speaker through a horn portion (acoustic tube).

### DETAILED DESCRIPTION

### Embodiments

As follows, detailed examples of the present disclosure will be described with reference to drawings. The following embodiments are examples, and the present disclosure is not limited to the embodiments.

### First Embodiment

The vehicle existence annunciator device is configured to notify existence of a vehicle by causing an alarm sound. The vehicle existence annunciator device may be equipped to, for example, a vehicle, such as an electric vehicle or a fuel cell electric vehicle, which is not equipped with an internal combustion engine. Alternatively, the vehicle existence annunciator device may be equipped to a vehicle, such as a hybrid vehicle, which is configured to stop its internal combustion engine while traveling and stopping. Alternatively, the vehicle existence annunciator device may be equipped to a vehicle, such as an idle-stop vehicle, which is configured to stop its internal combustion engine when stopping. Alternatively, the vehicle existence annunciator device may be equipped to a conventional vehicle configured to emit a small sound from its internal combustion engine and the vehicle when traveling.

The vehicle is equipped with a vehicular horn buzzer 5 configured to emit an alarm sound. The vehicular horn buzzer 5 is, for example, an electromagnetic warning device configured to emit an alarm sound when an occupant manipulates a horn buzzer switch device, such as a horn buzzer button mounted on a steering wheel. The vehicular horn buzzer 5 is, for example, affixed to a vehicular portion between a front grill, which is located at a front part of the vehicle and equipped for receiving inlet air, and a heat exchanger, such as a radiator for an air-conditioning device.

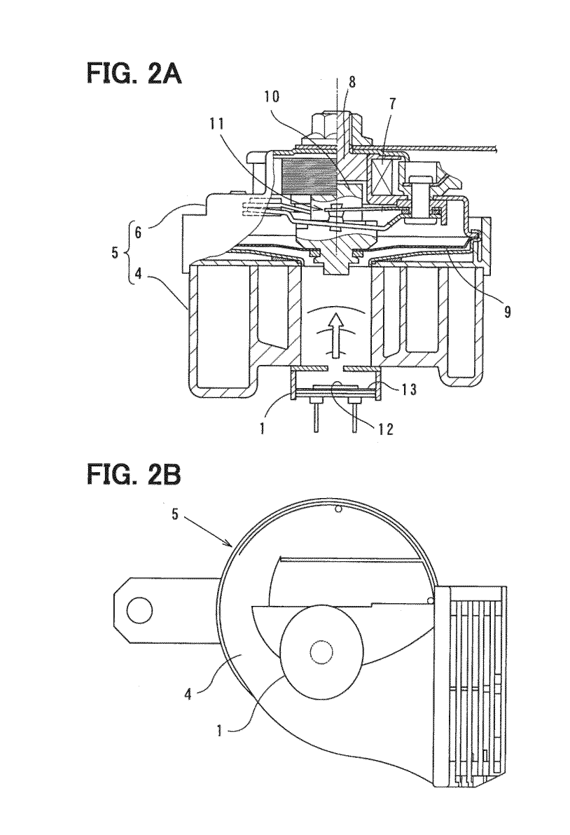

As shown in FIG. 2B, the vehicular horn buzzer 5 includes an alarm sound generation unit 6, which is configured to emit an alarm sound when supplied with electricity. The vehicular horn buzzer 5 further includes a horn portion 4, which is configured to enhance the alarm sound caused by the alarm sound generation unit 6 and to emit the enhanced alarm sound to the outside of the vehicle.

The alarm sound generation unit 6 has a generally-known configuration. The alarm sound generation unit 6 is equipped with a coil 7, which is configured to cause a magnetism when supplied with electricity. The alarm sound generation unit 6 is further equipped with a stationary iron core (magnetic attraction core) 8, which is configured to emit a magnetic attractive force in response to the magnetism caused by the coil 7. The alarm sound generation unit 6 is further equipped with a moving iron core (moving core) 10, which is supported by a center portion of a diaphragm 9 (vibrating plate) and is movable toward the stationary iron core 8. The alarm sound generation unit 6 is further equipped with a current interrupter 11, which is configured to connect and disconnect an electricity supply circuit of the coil 7 when the coil 7 is supplied with electricity.

The horn portion 4 is a spiral horn buzzer (trumpet unit) having a sound path, which enlarges from a sound inlet (horn buzzer inlet) toward a sound outlet (horn buzzer outlet). The alarm sound generation unit 6 is equipped to one lateral side of the horn portion 4. More specifically, the alarm sound generation unit 6 is equipped to, for example, a plane of the horn portion 4, which is perpendicular to the axis passing through the spiral center of the horn portion 4. The alarm sound generation unit 6 may be equipped to, for example, one plane of the horn portion 4 on the side of the heat exchanger when being equipped to the vehicle. The alarm sound generation unit 6 is configured to emit an alarm sound into the sound inlet located at the center of the horn portion 4.

The vehicle existence annunciator device includes a piezoelectric speaker 1, which is configured to emit an audible annunciation sound. The vehicle existence annunciator device further includes a control circuit 2, is configured to control electricity supplied to the piezoelectric speaker 1 by regulating a power supply voltage applied from a vehicular electric power source (battery) 20.

The piezoelectric speaker 1 is configured to generate a sound wave in an audible range and to emit an audible sound. The piezoelectric speaker 1 has a vibration system configured with a piezo-electric element 12 and a diaphragm 13. The vibration system of the piezoelectric speaker 1 has a primary resonance range (primary resonant frequency) in an audible range, such as about 2 kHz. More specifically, the piezoelectric speaker 1 according to the present embodiment functions to emit audible sound by utilizing an audio device, which is equipped to the vehicle originally for providing audible vehicle information, such as a voice and an alarm, to an occupant of the vehicle. The piezoelectric speaker 1 includes the piezo-electric element 12, which is extendable and contractible in response to application of a voltage thereto causing charge and discharge of an electric charge. The piezoelectric speaker 1 further includes the diaphragm 13, which actuates in response to extension and contraction of the piezo-electric element 12 to cause a compressional wave in the air.

The piezoelectric speaker 1 is affixed to the horn portion 4 of the vehicular horn buzzer 5. The piezoelectric speaker 1 is configured to generate an annunciation sound and to emit the annunciation sound into the center portion of the horn portion 4.

More specifically, the piezoelectric speaker 1 is located at a position opposed to the alarm sound generation unit 6. In the present configuration, the piezoelectric speaker 1 is equipped to the other lateral side of the horn portion 4. More specifically, the piezoelectric speaker 1 is equipped to, for example, a plane of the horn portion 4, which is perpendicular to the axis passing through the spiral center of the horn portion 4. The piezoelectric speaker 1 may be equipped to, for example, the other plane of the horn portion 4 on the side of the front grill when being equipped to the vehicle. The piezoelectric speaker 1 is configured to emit an annunciation sound into the sound inlet located at the center of the horn portion 4. In the present configuration, an annunciation sound generated by the piezoelectric speaker 1 is emitted through the horn portion 4 to the outside of the vehicle. Thus, a low-pitched sound component of an annunciation sound generated by the piezoelectric speaker 1 can be amplified by the horn portion 4, and the amplified low-pitched sound component can be emitted to the outside of the vehicle.

The control circuit 2 is configured to receive, from an engine control unit (ECU) or the like, vehicle information, such as a vehicle speed, when the vehicle travels. The control circuit 2 is further configured to cause the piezoelectric speaker 1 to emit an annunciation sound when an operating condition for emitting an annunciation sound is satisfied. The operating condition for emitting an annunciation sound may be satisfied when, for example, the vehicle speed is below a predetermined speed while the vehicle travels.

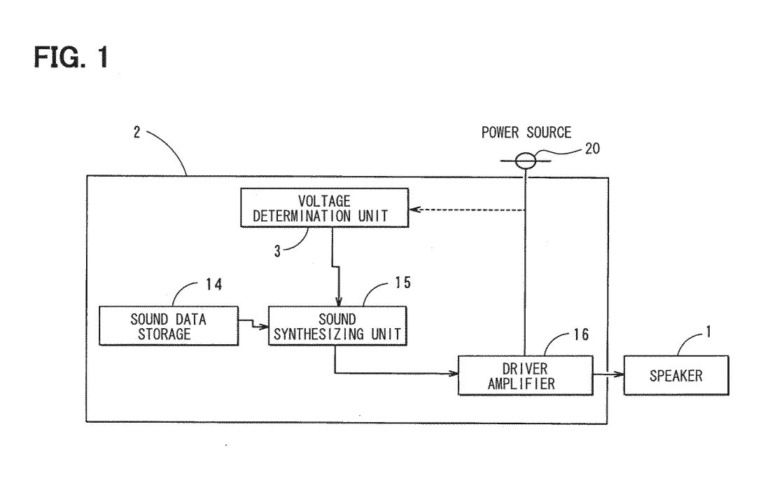

Referring to FIG. 1, the control circuit 2 includes an annunciation sound generation unit (sound synthesizing unit) 15 configured to emit a frequency signal (audible sound signal) for an annunciation sound according to data stored in a memory device (sound data storage) 14. The control circuit 2 further includes a driver amplifier 16 configured to amplify a frequency signal for an annunciation sound sent from the annunciation sound generation unit 15 and to drive the piezoelectric speaker 1. The control circuit 2 further includes a counter-voltage-reduction unit (voltage determination unit) 3 configured to monitor a power supply voltage applied from the vehicular electric power source 20 and to enhance a sound pressure level of a sound at a frequency, which is apt to linger in a human's ear, in the frequency signal for an annunciation sound, when the detected power supply voltage decreases to a value lower than the rating voltage of the vehicular electric power source 20.

The annunciation sound generation unit 15 is, for example, an annunciation sound generator program (sound software) stored in a microcomputer of the control circuit 2. The annunciation sound generation unit 15 is configured to synthesize a frequency signal for an annunciation sound (an electric signal at an audible frequency, audio signal) by utilizing a digital technology when an operating condition for emitting an annunciation sound is satisfied. It is noted that the annunciation sound generation unit 15 is not limited to an annunciation sound generating program. The annunciation sound generation unit 15 is configured to emit an annunciation sound with suppressed noisiness such that a human therearound can notice the annunciation sound and does not feel noisiness.

More specifically, the annunciation sound generation unit 15 according to the present embodiment is configured to emit a frequency signal including a frequency signal component, which is easily noticed by a human, and a frequency signal component, which alleviates a feeling of discomfort of the frequency. For easy understanding, one detailed example of the annunciation sound generation unit 15 according to the present embodiment will be described. The annunciation sound generation unit 15 is configured to emit, for example, a frequency signal of a chord sound including a low-pitched sound composing: a frequency signal at 4 kHz easily noticed by a human; a frequency signal at 2 kHz, which is the half of the frequency signal at 4 kHz; a frequency signal at 1 kHz, which is the half of the frequency signal at 2 kHz; and a frequency signal at 500 Hz, which is the half of the frequency signal at 1 kHz.

The driver amplifier 16 is an amplification unit, such as a B-class B amplifier or a D-class D amplifier, configured to drive the piezoelectric speaker 1 according to the frequency signal for an annunciation sound, which is generated by the annunciation sound generation unit 15. The driver amplifier 16 is configured to control a voltage applied to the piezoelectric speaker 1 thereby to control the charge-and-discharge state of the piezo-electric element 12. Thus, the driver amplifier 16 causes the piezoelectric speaker 1 to emit a sound wave (audible sound) to cause an annunciation sound.

The counter-voltage-reduction unit 3 is a control program stored in the microcomputer of the control circuit 2. The counter-voltage-reduction unit 3 includes a voltage determination unit configured to determine whether the power supply voltage, which is applied from the vehicular electric power source 20, decreases below a predetermined threshold. The predetermined threshold is, for example, 11 V and is set to be lower than the rating voltage of the vehicular electric power source 20. When the voltage determination unit determines that the power supply voltage is lower than the threshold and is in a low-voltage state, the counter-voltage-reduction unit 3 manipulates the operation state of the annunciation sound generation unit 15 to enhance a sound pressure level at a frequency, which is apt to linger (easily lingers) in a human's ear. It is noted that the counter-voltage-reduction unit 3 is not limited to a control program.

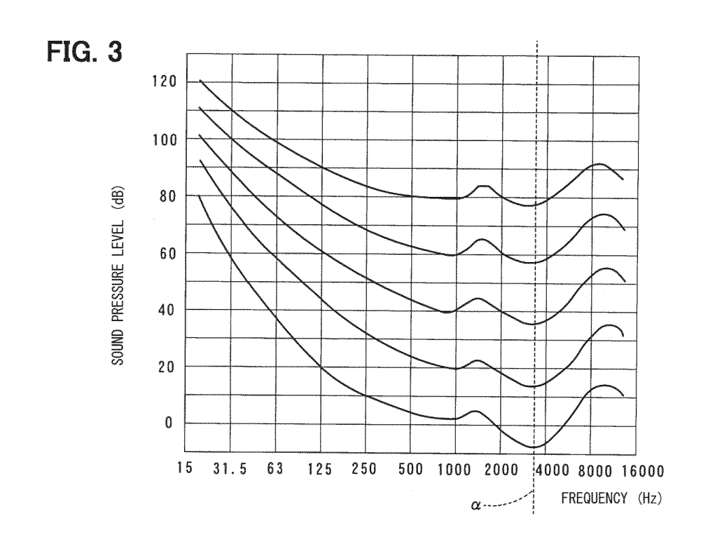

Specifically, as shown by a sound pressure curve in FIG. 3, the frequency, which easily lingers in a human's ear, is remarkable in the range, in particular, between 3 kHz and 5 kHz, and is significantly particular showing a maximum characteristic around 3.6 kHz, as shown by the dashed line α. In consideration of this, the counter-voltage-reduction unit 3 according to the present embodiment manipulates the operation state of the annunciation sound generation unit 15 to enhance the output signal at 4 kHz, compared with a normal condition, on determination of the voltage reduction when the power supply voltage is less than, for example, 11V.

(Effect 1 of First Embodiment)

The vehicle existence annunciator device according to the embodiment is configured, when the power supply voltage decreases due to aging of the battery, decrease in temperature of the battery, or the like, to enhance the sound pressure level of the annunciation sound at a frequency, which easily lingers in a human's ear, and to emit the annunciation sound, instead of emitting an annunciation sound, which is suppressed in noisiness. According to the present configuration, suppression of noisiness may be, more or less, impaired, due to enhancement of the sound pressure level at a frequency, which easily lingers in a human's ear, nevertheless, the annunciation sound can be rendered easy noticeable by people therearound. In this way, even when the power supply voltage decreases, noticeability of existence of the vehicle can be maintained. Thus, the present configuration enables to avoid a concern about loss of noticeability of an annunciation sound due to decrease in output voltage of the vehicular electric power source 20, without increase in the number of speakers equipped in the piezoelectric speaker 1 for emitting an annunciation sound.

(Effect 2 of First Embodiment)

The vehicle existence annunciator device according to the embodiment employs the piezoelectric speaker 1 as one example of a speaker for emitting an annunciation sound. It is noted that, the piezoelectric speaker 1 is combined with the horn portion 4 of the vehicular horn buzzer 5 thereby to enable to enhance a sound pressure of a low-pitched sound, similarly to a configuration where a large-sized dynamic speaker, such as a woofer, is employed. Therefore, a manufacturing cost for producing the vehicle existence annunciator device, which is configured to emit a low-pitched sound, specifically, to emit an annunciation sound including a low-pitched sound component, can be reduced.

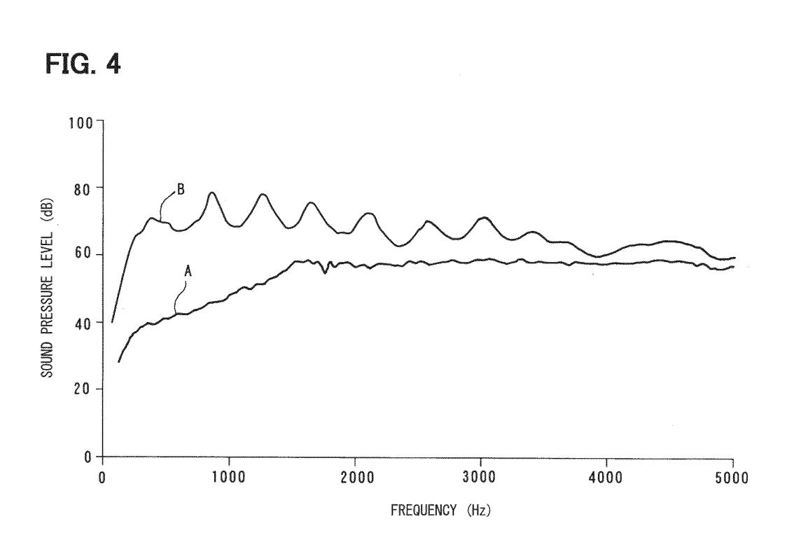

The present configuration will be described further in detail. In FIG. 4, the solid line A represents a frequency characteristic (replayable frequency) of a playback sound, which is emitted from the piezoelectric speaker 1 directly in the air when the piezoelectric speaker 1 being a single component receives a sign-wave sweep signal at a predetermined voltage. The sign-wave sweep signal is a variable signal swinging in frequency from a low-pitched sound frequency to a high-pitched sound frequency. In the present embodiment, the piezoelectric speaker 1 being a small dynamic speaker is employed. It is obvious from the solid line A in FIG. 4, it is difficult to cause the piezoelectric speaker 1 to emit a compressional wave at a low frequency in the air. Consequently, the piezoelectric speaker 1 is capable of emitting a low low-pitched sound in sound pressure.

In consideration of this, as described above with reference to FIGS. 2A, 2B, the piezoelectric speaker 1 is affixed to the horn portion 4 of the vehicular horn buzzer 5 thereby to enable the piezoelectric speaker 1 to emit an annunciation sound in the center, i.e., acoustic inlet of the horn portion 4. With the present configuration, an annunciation sound generated by the piezoelectric speaker 1 is emitted through the horn portion 4 to the outside of the vehicle. Thus, the low-pitched sound component generated by the piezoelectric speaker 1 can be amplified by the horn portion 4 and can be emitted to the outside.

In FIG. 4, the solid line B represents a frequency characteristic of a playback sound, which is emitted from the horn portion 4 in the air when the piezoelectric speaker 1 equipped to the horn portion 4 receives a sign-wave sweep signal at a predetermined voltage. As being obvious by the solid line B in FIG. 4, even though the piezoelectric speaker 1 is small, the horn portion 4 effectively regulates aerial vibration caused by the piezoelectric speaker 1. Thus, aerial vibration at a low frequency can be effectively emitted as a low-pitched sound (sound wave) to the outside of the horn portion 4, without a large loss. In this way, the sound pressure of the low-pitched sound can be effectively enhanced.

(Effect 3 of First Embodiment)

In the present embodiment, the piezoelectric speaker 1 for emitting an audible sound is employed as one example of a small dynamic speaker. The piezoelectric speaker 1 is low-cost, and therefore, the manufacturing cost for the vehicle existence annunciator device can be reduced. In addition, the piezoelectric speaker 1 is, in general, small and light-weight, as compared with a corn speaker. Therefore, the piezoelectric speaker 1 is excellent in mountability to the vehicular horn buzzer 5. Furthermore, the vehicular horn buzzer 5 equipped with the piezoelectric speaker 1 can be restricted from increasing in size and weight. Therefore, mountability of the vehicular horn buzzer 5 equipped with the piezoelectric speaker 1 to the vehicle can be enhanced.

### Second Embodiment

In the above-described first embodiment, the counter-voltage-reduction unit 3 is configured to enhance the sound pressure level at a frequency, which easily lingers in a human's ear, when the power supply voltage decreases. To the contrary, according to the present second embodiment, when the power supply voltage decreases, the counter-voltage-reduction unit 3 is configured to emit an annunciation sound, in which a sound pressure level at a resonant frequency of the horn portion 4 (acoustic tube) is enhanced.

As shown by the solid line B in FIG. 4, a playback sound with the horn portion 4 of the vehicular horn buzzer 5 contains multiple peaks (peak portions). That is, in a playback sound with the horn portion 4, multiple resonant frequencies exist in its audible range. More specifically, in a playback sound with the horn portion 4, the primary resonant frequency, which has a decisive influence to the tone of the playback sound, exists in a range between 300 Hz and 600 Hz. In addition, resonance occurs at frequencies, which are in multiple relation to the primary resonant frequency.

In consideration of this, the counter-voltage-reduction unit 3 according to the second embodiment is configured, when the power supply voltage decreases, to emit an annunciation sound containing a sound pressure level, which is enhanced at a frequency, which easily lingers in a human's ear, and at a resonant frequency of the horn portion 4. Specifically, for example, the counter-voltage-reduction unit 3 according to the second embodiment is configured, when the power supply voltage decreases below the threshold, to emit an annunciation sound containing a sound pressure level, which is enhanced at 3 kHz, among the multiple peaks shown by the solid line B in FIG. 4. Herein, the sound pressure level is enhanced at 3 kHz, since, in the one example, 3 kHz is the closest to the frequency, which easily lingers in a human's ear. It is noted that, the 3 kHz is one example of the resonant frequency of the horn portion 4.

(Effect 1 of Second Embodiment)

The vehicle existence annunciator device according to the embodiment is configured, when the power supply voltage decreases due to aging of the battery, decrease in temperature of the battery, or the like, to enhance the sound pressure level of the annunciation sound at a resonant frequency of the horn portion 4, and to emit the annunciation sound, instead of emitting an annunciation sound, which is suppressed in noisiness. The sound pressure level of the annunciation sound at a resonant frequency of the horn portion 4 can be enhanced efficiently. With the present configuration, even when the power supply voltage decreases, it is possible to restrict the sound pressure level of an annunciation sound at a partial frequency from decreasing. In this way, suppression of noisiness may be, more or less, impaired, nevertheless, noticeability of existence of the vehicle can be maintained. Thus, the present configuration enables to avoid a concern about loss of noticeability of an annunciation sound due to decrease in output voltage of the vehicular electric power source 20, without increase in the number of speakers.

(Effect 2 of Second Embodiment)

The vehicle existence annunciator device according to the present embodiment utilizes the horn portion 4 of the vehicular horn buzzer 5 as an acoustic tube. Therefore, an exclusive acoustic tube need not be equipped to the piezoelectric speaker 1. Consequently, manufacturing cost for the vehicle existence annunciator device can be reduced. In addition, mountability of the vehicle existence annunciator device to the vehicle can be also enhanced.

### INDUSTRIAL APPLICABILITY

In the above embodiments, the annunciation sound generation unit 15 is directly operated in order to enhance the sound pressure level at a part of the frequency signal, which is apt to linger (easily lingers) in a human's ear or which is the resonant frequency of the acoustic tube, when the power supply voltage decreases. It is noted that, the configuration is not limited to those in the above-described embodiments. For example, the frequency signal for an annunciation sound audio signal generated by the annunciation sound generation unit 15 may be modified with another device such as a parametric equalizer. Alternatively, the frequency signal for an annunciation sound audio signal generated by the annunciation sound generation unit 15 may be added with a signal at a predetermined frequency, which easily lingers in a human's ear or which is the resonant frequency of the acoustic tube.

In the above embodiments, a chord sound is emitted as one example of an annunciation sound. It is noted that, the configuration is not limited to those in the above-described embodiments. For example, a sound, which is other than an annunciation sound, such as a dummy engine sound, a voice, a music, and/or the like, may be emitted, instead of an annunciation sound. That is, it may be suffice to enhance a sound pressure level at a partial frequency, which easily lingers in a human's ear or which is a resonant frequency of the acoustic tube, when the power supply voltage decreases.

In the above embodiments, the sound pressure level at a partial frequency, which easily lingers in a human's ear or which is a resonant frequency of the horn portion 4, is enhanced, when the power supply voltage decreases below the threshold. It is noted that, the sound pressure level at a partial frequency, which easily lingers in a human's ear or which is a resonant frequency of the horn portion 4, may be continually or gradually enhanced according to decrease in the level of the power supply voltage.

In the above embodiments, a single element of the piezoelectric speaker 1 is equipped to an acoustic tube, such as the horn portion 4. Alternatively, multiple elements of the piezoelectric speakers 1 may be equipped to an acoustic tube, such as the horn portion 4 and the like of the vehicular horn buzzer 5.

In the above embodiments, the piezoelectric speaker 1 is employed as one example of a dynamic speaker. It is noted that, the piezoelectric speaker 1 is not limited to an example of a dynamic speaker. A speaker other than the piezoelectric speaker 1 may be employable. For example, a speaker configured to emit directly an audible sound, such as a small corn speaker, may be employable.

In the above embodiments, only a dynamic speaker, such as the piezoelectric speaker 1, is employed to emit an annunciation sound. It is noted that, a parametric speaker may be additionally employed in the vehicle existence annunciator device. In this case, the dynamic speaker may be caused to emit an annunciation sound through the acoustic tube, such as the horn portion 4, to the outside the vehicle, and the parametric speaker may be additionally caused to emit an annunciation sound to the outside the vehicle.

In the above embodiments, the horn portion 4 of the vehicular horn buzzer 5 is utilized as an acoustic tube of the piezoelectric speaker 1. It is noted that, an acoustic tube other than the vehicular horn buzzer 5 may be independently employed in the vehicle existence annunciator device exclusively for the piezoelectric speaker.

In the above embodiments, a dynamic speaker, such as the piezoelectric speaker 1, is employed as one example of a speaker for emitting an annunciation sound, independently from the vehicular horn buzzer 5. It is noted that, the alarm sound generation unit 6 may be configured to emit an annunciation sound. That is, the vehicular horn buzzer 5 may be configured to emit both an alarm sound and an annunciation sound.

The above-described vehicle existence annunciation device may be configured to emit an annunciation sound with a sound pressure level enhanced at a frequency, which is apt to linger in a human's ear, when the power supply voltage decreases. The present configuration enhances the sound pressure level at a frequency, which is apt to linger (easily lingers) in a human's ear, thereby to render an annunciation sound further noticeable easily. In this way, even when the power supply voltage decreases, noticeability of existence of the vehicle can be maintained. Thus, the present configuration enables to avoid a concern about loss of noticeability of an annunciation sound due to decrease in output voltage of the vehicular electric power source, without increase in the number of speakers.

The vehicle existence annunciator device may be configured to emit an annunciation sound with a sound pressure level enhanced at the resonant frequency of the acoustic tube, when the power supply voltage decreases. The present configuration enables to enhance efficiently the sound pressure level of the annunciation sound at the resonant frequency of the acoustic tube. In this way, even when the power supply voltage decreases, noticeability of existence of the vehicle can be maintained. Thus, the present configuration enables to avoid a concern about loss of noticeability of an annunciation sound due to decrease in output voltage of the vehicular electric power source, without increase in the number of speakers.

The acoustic tube may be configured to utilize the horn portion of the vehicular horn buzzer for emitting an alarm sound. The present configuration enables to reduce a manufacturing cost of the acoustic tube.

As described above, the vehicle existence annunciator device may be configured to emit an annunciation sound to the outside of the vehicle, when the operating condition for notifying existence of the vehicle is satisfied. The vehicle existence annunciator device may include the speaker 1, such at the piezoelectric speaker 1, configured to emit an annunciation sound. The vehicle existence annunciator device may further include the control circuit 2 configured to control electricity supplied to the speaker 1 with the power supply voltage applied from the vehicular electric power source.

The control circuit 2 according to the first embodiment may include the counter-voltage-reduction unit (voltage determination unit in FIG. 1) 3 configured to monitor the power supply voltage applied from the vehicular electric power source and to enhance the sound pressure level of the sound at the frequency, which is apt to linger in a human's ear, in the frequency signal for an annunciation sound, when the detected power supply voltage decreases.

The control circuit 2 according to the second embodiment may include the counter-voltage-reduction unit 3 configured to monitor the power supply voltage applied from the vehicular electric power source and to enhance the sound pressure level of the sound at the resonant frequency of the acoustic tube 4, such as the horn portion 4 of the vehicular horn 5, in the frequency signal for an annunciation sound, when the detected power supply voltage decreases.

The first embodiment may be combined with the second embodiment. The above processings such as calculations and determinations are not limited being executed by the devices 3, 14, 15. The control unit may have various structures including the devices 3, 14, 15 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A vehicle existence annunciator device configured to drive a speaker with an electric power, which is supplied from a vehicular electric power source, to emit an annunciation sound to an outside of a vehicle, when an operating condition for notifying existence of the vehicle is satisfied, the vehicle existence annunciator device comprising:
a voltage determination unit configured to determine whether a power supply voltage applied from the vehicular electric power source to the vehicle existence annunciator device decreases; and
a counter-voltage-reduction unit configured to enhance a sound pressure level at a frequency, which is apt to linger in a human's ear, when the voltage determination unit determines that the power supply voltage decreases.

2. A vehicle existence annunciator device configured to drive a speaker with an electric power, which is supplied from a vehicular electric power source, to emit an annunciation sound to an outside of a vehicle, when an operating condition for notifying existence of the vehicle is satisfied, wherein the speaker is configured to emit the annunciation sound through an acoustic tube, the vehicle existence annunciator device comprising:
a voltage determination unit configured to determine whether a power supply voltage applied from the vehicular electric power source to the vehicle existence annunciator device decreases; and
a counter-voltage-reduction unit configured to enhance a sound pressure level at a resonant frequency of the acoustic tube, when the voltage determination unit determines that the power supply voltage decreases.

3. The vehicle existence annunciator device according to claim 2, wherein the acoustic tube is configured to utilize a horn portion of a vehicular horn buzzer, which is for emitting an alarm sound.

4. The vehicle existence annunciator device according to claim 1, wherein the counter-voltage-reduction unit is further configured to enhance a sound pressure level at a resonant frequency of an acoustic tube through which the speaker is configured to emit the annunciation sound, when the voltage determination unit determines that the power supply voltage decreases.

5. The vehicle existence annunciator device according to claim 2, wherein the counter-voltage-reduction unit is further configured to enhance a sound pressure level at a frequency, which is apt to linger in a human's ear, when the voltage determination unit determines that the power supply voltage decreases.

6. A method for controlling a vehicle existence annunciator device to drive a speaker with an electric power, which is supplied from a vehicular electric power source, to emit an annunciation sound to an outside of a vehicle, the method comprising:
determining whether a power supply voltage applied from the vehicular electric power source to the vehicle existence annunciator device decreases below a threshold; and
enhancing, on determination that the power supply voltage decreases below the threshold, at least one of:
a sound pressure level at a frequency, which is apt to linger in a human's ear; and
a sound pressure level at a resonant frequency of an acoustic tube through which the speaker is configured to emit the annunciation sound.

7. A non-transitory computer readable medium comprising instructions executed by a computer, the instructions including the method according to claim 6.

8. A vehicle existence annunciator device configured to drive a speaker with an electric power, which is supplied from an electric power source of a vehicle, to emit an annunciation sound to an outside of the vehicle, the vehicle existence annunciator device comprising:
a voltage determination unit configured to determine whether a power supply voltage applied from the electric power source to the vehicle existence annunciator device decreases below a threshold; and
a counter-voltage-reduction unit configured, when the voltage determination unit determines that the power supply voltage decreases below the threshold, to enhance at least one of:
a sound pressure level at a frequency, which is apt to linger in a human's ear; and
a sound pressure level at a resonant frequency of an acoustic tube through which the speaker is configured to emit the annunciation sound.

9. The vehicle existence annunciator device according to claim 8, wherein the acoustic tube is configured to utilize a horn portion of a vehicular horn buzzer, which is for emitting an alarm sound.
